(19) United States
(12) Patent Application Publication
(10) Pub. No.: US 2022/0119598 A1
(43) Pub. Date: Apr. 21, 2022

(54) METHOD FOR PREPARING STARCH BLENDS

(71) Applicant: BASF SE, Ludwigshafen am Rhein (DE)

(72) Inventors: Robert LOOS, Ludwigshafen am Rhein (DE); Norbert EFFEN, Ludwigshafen am Rhein (DE); Nora SCHLUTT, Ludwigshafen am Rhein (DE); Carsten SINKEL, Ludwigshafen am Rhein (DE); Joerg AUFFERMANN, Ludwigshafen am Rhein (DE)

(21) Appl. No.: 17/427,158

(22) PCT Filed: Jan. 27, 2020
(86) PCT No.: PCT/EP2020/051857

§ 371 Date: Jul. 30, 2021

(30) Foreign Application Priority Data
Jan. 30, 2019 (EP) 19154571.4

(51) Int. Cl. C08J 3/00; B01F 23/40; B01F 23/50; B01F 23/43; B01F 23/53; B01F 27/42; C08J 3/18; C08L 67/02

(52) U.S. Cl. CPC C08J 3/005; B01F 23/482; B01F 23/511; B01F 23/43; B01F 2101/2805; B01F 27/421; C08J 3/18; C08L 67/02; B01F 23/53

(57) ABSTRACT

The present invention relates to a single-stage process for the production of starch blends in a twin-screw extruder or two twin-screw extruders arranged in series, where
i) the starch, together with a plasticizer, passes through a wetting section of length 8D to 30D in an extruder or in a wetting section of length 8D to 80D if two extruders are used at temperatures below the gelatinization temperature of the starch, with mixing, where D is defined as the screw diameter of the screw cylinder and the wetting section is defined as starting at that point on the extruder screw at which the starch and the entire or partial quantity of plasticizer encounter one another and ending at that point in the extruder at which the starch is gelatinized and is digested to give thermoplastic starch;
ii) in a plastifying section of length 10D to 50D the extruder temperature is adjusted stepwise to above 130° C., where the starch is digested, destructured and thermoplastified, and is dispersed in a starch-immiscible polymer, and a water content below 5%, based on the starch blend, is established before the material leaves the extruder;
where the starch-immiscible polymer is added in molten or granular form at any desired point in the extruder, and a mixture of all of the components present is consequently produced.

The present invention relates to a single-stage process for the production of starch blends in a twin-screw extruder or two twin-screw extruders arranged in series, where
i) the starch, together with a plasticizer, passes through a wetting section of length 8D to 30D in an extruder or in a wetting section of length 8D to 80D if two extruders are used at temperatures below the gelatinization temperature of the starch, with mixing, where D is defined as the screw diameter of the screw cylinder and the wetting section is defined as starting at that point on the extruder screw at which the starch and the entire or partial quantity of plasticizer encounter one another and ending at that point the extruder at which the starch is gelatinized and is digested to give thermoplastic starch;
ii) in a plastifying section of length 10D to 50D the extruder temperature is adjusted stepwise to above 130° C., where the starch is digested, destructured and thermoplastified, and is dispersed in a starch-immiscible polymer, and a water content below 5%, based on the starch blend, is established before the material leaves the extruder;
where the starch-immiscible polymer is added in molten or granular form at any desired point in the extruder, and a mixture of all of the components present is consequently produced.

Starch blends, in particular biodegradable starch blends, have already been known for many decades from the prior art, and various processes for production thereof are described in the literature. A distinction can be drawn in general terms between single- and two-stage processes.

A single-stage process which would permit higher throughput (in kg/h) and which would provide high product quality comparable with, or better than, that provided by a two-stage process would be significantly preferable in respect of process cost and of energy consumption. In two-stage processes, the starch is digested in a separate step to give the thermoplastified starch (TPS).

In the single-stage process, the plastification of the starch and the mixing with a further polymer take place in one process pass in the same machine or in two machines arranged in series, operations here being mostly carried out in twin-screw extruders. Plasticizers are used for the plastification of the starch, examples being glycerol, oligoglycerol, pentaerythritol and sorbitol, preferably in mixtures with water.

The starting materials can be added in various ways: In direct addition, all of the starting materials, for example starch, polymer, or optionally further additives and solid plasticizers, form an initial charge in the 1st zone, and/or the liquid plasticizers, e.g. polyols and/or water are then added in the downstream zone (e.g. US 2011/0177275A1).

EP 906367A1 and EP 2467418A1 disclose that the starch is first plastified with plasticizers at temperatures above 140° C. The resultant thermoplastified starch (TPS) is devolatilized, and the water is thus substantially removed. Only then is the further polymer added, in molten or granular, solid form.

A feature common to all of the processes described in the prior art is that the gelatinization/plastification of the starch takes place shortly after the addition of the plasticizer at temperatures above the gelatinization temperature.

One of the disadvantages of the single-stage process described above is the low throughput. By way of example, EP 906367A1 achieves only 50 to 60 kg/h in a 45 mm extruder, and EP 2467418A1 achieves only 10 kg/h in a 26 mm extruder. Despite the low throughput, the TPS generally exhibits only coarse-particle dispersion in the polymer matrix. EP 2467418A1 was able to compensate this disadvantage to some extent by adding specific and expensive compatibilizers based on maleic anhydride. Finally, polymer strands of the abovementioned starch blends films produced therefrom exhibit high roughness and undispersed particles, attributable to agglomerated, poorly dispersed starch particles. The low fill level in the extruder in the prior art moreover leads to introduction of a disproportionately large amount of energy, because of the resultant high shear load introduced into the small quantity of melt, and thus leads, because of the resultant relatively high temperatures, to undesired light- to dark-brown discoloration effects in the products produced from these starch blends.

The present invention was therefore aimed at providing a single-stage process with high throughput for the production of blends with fine-particle dispersion of the TPS in the polymer matrix, and with high whiteness.

Surprisingly, the object adopted is achieved via the process described in the introduction, where the starch is wetted by the plasticizer in a relatively long wetting section of the extruder at internal temperatures below the gelatinization temperature of the starch, before the starch undergoes any digestion.

The process of the invention is described in more detail below.

Gelatinization, i.e. digestion of the starch grains, takes place at a temperature which depends primarily on the nature of the starch used, in particular its water content, and also on the quantity and structure of the plasticizer and its water content (see by way of example Tan et al., Carbohydrate Polymers 2004, 58, 191-204; Taghizadeh & Favis, Carbohydrate Polymers 2013, 92, 1799-1808). Within the plasticizer concentration ranges relevant for starch blends, gelatinization of the starch generally begins at above 70 to 100° C. In step i) of the process of the invention it is therefore preferable to set a resultant extruder temperature below 100° C., preferably below 85° C. and with particular preference below 60° C.

A defined wetting section in the extruder (step i) is necessary in order to achieve adequate and uniform wetting of the starch by the plasticizer at high throughputs. The wetting section is measured from the point at which the starch and the plasticizer, or a partial quantity of the plasticizer, first encounter one another to the point at which the temperature of the extruder is increased beyond the temperature at which the starch begins to gelatinize (gelatinization temperature). The length of the wetting section in the extruder is generally 8D, (i.e. 8×the diameter of the screw cylinder), and preferably at least 12D. If operations are carried out with two extruders arranged in series, the first extruder is generally utilized for the wetting of the starch, and its length is usually 8D to 80D and preferably 12D to 60D. The additional residence time of the starch together with the plasticizer leads to products which comprise only a very small content of agglomerated starch particles which have not been completely digested. Economic considerations dictate that wetting sections longer than 30D in a single extruder and 60D if two extruders are used are of relatively little interest.

In an embodiment A of the process of the invention, only conveying screw elements are installed in the wetting section of the extruder. In this mode of operation it is possible that the starch-immiscible polymer is added at any desired point of the wetting section; this point may also be in zone 1 at the ingoing end of the extruder. The polymer is preferably added in solid form. The embodiment A of the process with early addition of the polymer in solid form in zone 1 of the extruder is illustrated in inventive example 8.

Installed in the wetting section of the extruder in a preferred embodiment B there are, alongside conveying screw elements, at least one, preferably two or more, intensive-mixing screw elements which additionally promote uniform wetting of the starch by the plasticizer and again reduce the number of agglomerated starch particles in the final product (step i). The expression “intensive-mixing screw elements” means by way of example kneading blocks, toothed mixing elements or other shearing elements. In embodiment B it has proven advantageous to add the starch-immiscible polymer, preferably in solid form, only downstream of these intensive-mixing screw elements, but upstream of the end of the wetting section of the extruder. This preferred mode of operation of embodiment B is illustrated in inventive examples 1 to 7.

The efficient wetting of the starch by the plasticizer in embodiment B has proven successful in particular in modes of operation with high throughputs above 100 kg/h, in particular above 120 kg/h and with particular preference above 150 kg/h, based in each case on a twin-screw extruder with a screw diameter of 40 mm, and based on the anhydrous final product (starch blend). Throughputs achieved in a twin-screw extruder with 65 mm screw diameter are above 400 kg/h, in particular above 500 kg/h and with particular preference above 600 kg/h—based on the anhydrous final product.

In particular embodiment B is also suitable for the production of starch blends with very fine dispersion of the TPS in the polymer matrix, or indeed co-continuous structures with a very fine lamellar structure. Surprisingly, good dispersion was even achieved in starch blends having high TPS contents above 29%, indeed above 39% and indeed in particular above 44%.

In both embodiments it has been found advantageous to introduce the starch-immiscible polymer in solid form (e.g. as granulate) specifically before the thermoplastification of the starch, i.e. at temperatures below the gelatinization point of the starch/plasticizer mixture, so that the melting of the polymer and the thermoplastification of the starch take place simultaneously in the subsequent melting zone.

In principle, it is possible to add the starch-immiscible polymer at any desired point of the extruder (step ii). However, downstream of addition of the polymer there must be an adequate screw length to allow any necessary melting of the polymer (if the polymer is added in solid form), and to ensure mixing with the starch (thermoplastified or not yet thermoplastified) and dispersion of the thermoplastified starch into the polymer matrix.

In order to provide any necessary melting of the starch-immiscible polymer in step ii) and to digest, destructure, and thermoplastify the starch and disperse same in the molten polymer, the internal temperature of the extruder is increased stepwise along the plastifying section up to temperatures above 130° C. It is preferable that barrel temperatures set in the plastifying section, optionally rising to the discharge die of the extruder, start at 90° C. and end at 260° C., preferably ending at 230° C. and with particular preference ending at 220° C., and where the temperature of the polymer melt at discharge from the die is kept below 250° C., with preference below 240° C., and with particular preference below 230° C.

The comparatively low-temperature mode of operation in step i) has the advantage that during the further course of the extrusion process the mixing and homogenization of the melt takes place in the presence of a considerable quantity of water, generally between 1 and 20% by weight, preferably 3 and 15% by weight, particularly preferably 5 and 10% by weight, based on the entirety of the anhydrous final products. The starch is thus very substantially protected from any disadvantageous thermal degradation involving discoloration. The high water content present at least at the beginning of the plastifying section then facilitates homogeneous fine-particle dispersion of the starch in the polymer matrix. The water content which is present in the mixture, or preferably melt, and which results from the water introduced by the starch, or by the plasticizer or plasticizer mixture used, or via separate introduction, is moreover reduced in the step ii), for example by means of lateral devolatilization, so that said content on discharge from the extruder (at the discharge die) is below 5%, based on the starch blend. In the case of granulation of the starch blend by way of an underwater pelletizer, it is advantageous to set a water content at the discharge die that is below 3%, based on the starch blend. If a strand pelletizer is used, the water content is generally set to below 2% and preferably below 1%, based on the starch blend.

The materials used as components in the process of the invention are described in more detail below:

Starch used generally comprises native starch. Native starch takes the form of highly crystalline grains (granula) whose melting point is above their decomposition temperature. Native starch generally comprises a not inconsiderable proportion of relatively large grains with diameter above 10 micrometers, and in non-digested and non-thermoplastified form is therefore not suitable for the production of high-quality thin films. The expression ‘native starch’ generally means corn starch, potato starch, wheat starch, pea starch or rice starch or a mixture thereof. In particular, the expression ‘native starch’ means wheat starch, and with particular preference corn starch or potato starch.

The literature describes numerous low-molecular-weight and relatively high-molecular-weight compounds as plasticizers for starch. Materials that have proven successful for the present process are in particular water and polyols, and also mixtures thereof. Among the polyols, preference is given to glycerol, sorbitol, sorbitol esters, oligomerized glycerol and pentaerythritol, and particular preference is given to glycerol, sorbitol, and oligomerized glycerol (oligoglycerol). Preferred compositions of the oligoglycerol used are described in WO 2012/017095 and WO 2017/153431; in particular, in order very substantially to avoid evaporation of the monoglycerol during subsequent film extrusion, the monoglycerol content of the oligoglycerol is preferably below 10% by weight.

Sorbitol is in particular preferred as plasticizer, and preference is in particular given here to an aqueous sorbitol solution whose water content is 5 to 80%, preferably 5 to 50% and particularly preferably 10 to 35%.

An aqueous sorbitol solution which has been produced by using incompletely depolymerized starch solution and which still comprises significant proportions of at least 5%, preferably more than 10% and particularly preferably more than 15%, based on the anhydrous mixture, of compounds having higher molecular weight than sorbitol has been identified as particularly preferred plasticizer.

The plasticizer (without water content thereof) is generally used in a ratio to the native starch (without water content thereof) that is 5 to 40% by weight, preferably 10 to 30% by weight and with particular preference 15 to 25% by weight.

The water content which is present in the extruder mixture before devolatilization and which results from the water introduced by the starch, or by the plasticizer or plasticizer mixture used, or via separate introduction into the extruder, is generally between 1 and 20% by weight, preferably 3 and 15% by weight, particularly preferably 5 and 10% by weight, based on the entirety of the anhydrous final products. Mixtures which have proven advantageous for optimizing water content in the extruder and preventing said content from becoming excessive comprise an aqueous sorbitol solution with oligoglycerols in a sorbitol:oligoglycerol ratio of 15:85 to 75:25, based in each case on the quantitative ratio of the anhydrous sorbitol solution inclusive of any higher oligomers present, calculated as ratio to the anhydrous oligoglycerol mixture.

The expression “starch-immiscible polymers” means by way of example polyethylene or polypropylene, and in particular here polymers produced from renewable feedstocks, polystyrene, and with particular preference polyesters, where these are biodegradable in accordance with DIN EN 13432.

Among the latter are in particular polyesters of the diol-dicarboxylic-acid type, and in turn here a distinction is drawn between aliphatic polyesters composed of aliphatic diols and aliphatic diacids and aliphatic-aromatic polyesters composed of aliphatic diols and aliphatic and aromatic diacids. A feature common to these polyesters is that they are biodegradable in accordance with DIN EN 13432.

Among the biodegradable, aliphatic-aromatic polyesters that are in particular preferred are linear, non-chain-extended polyesters of the type described by way of example in WO 92/09654, and preferably chain-extended and/or branched polyesters of the type described by way of example in WO 96/15173, WO-A 2006/097353 or WO 98/12242. In particular, the expression “aliphatic-aromatic polyesters” means products such as Ecoflex® (BASF SE) and Origo-Bi® (Novamont).

Among the particularly preferred aliphatic-aromatic polyesters are polyesters which comprise, as substantial components:
A) an acid component made of:
   a1) 30 to 99 mol %, preferably 30 to 70 mol %, of an aliphatic C₄-C₁₈-dicarboxylic acid, for example preferably succinic acid, adipic acid, sebacic acid, azelaic acid or brassilic acid or ester-forming derivatives thereof, or a mixture thereof, or a mixture of sebacic acid with adipic acid or succinic acid;
   a2) 1 to 70 mol %, preferably 30 to 70 mol %, of a terephthalic acid or furandicarboxylic acid or ester-forming derivative thereof or mixture thereof and
   B) 98.5 to 100 mol %, based on the acid component A, of a C₂-C₆-diol component, for example preferably 1,3-propanediol and 1,4-butanediol and with particular preference 1,4-butanediol produced from renewable feedstocks;
      and
   C) 0 to 1.5 mol %, preferably 0.01 to 1 mol %, based on the acid component A, of a component selected from
      c1) a compound having at least three groups capable of ester formation,
      c2) a di- or polyisocyanate,
      c3) a di- or polyepoxide,
      or a mixture of c1) to c3).

Preference is in particular given to the following aliphatic-aromatic polyesters: polybutylene sebacate-co-terephthalate (PBSeT), polybutylene azelate-co-terephthalate (PBAzT), polybutylene adipate-co-terephthalate (PBAT), polypropylene adipate-co-terephthalate (PPrAT), polybutylene succinate-co-terephthalate (PBST) or polybutylene sebacate-co-adipate-co-terephthalate (PBSeAT) or polybutylene sebacate-co-succinate-co-terephthalate (PBSeST) or a mixture of two or more of the abovementioned polyesters. The abovementioned aliphatic-aromatic polyesters preferably comprise, as diol component, 1,4 butanediol from renewable sources.

The preferred aliphatic-aromatic polyesters are characterized by a molar mass (M) in the range 1000 to 100 000, in particular in the range 9000 to 75 000 g/mol, preferably in the range 10 000 to 50 000 g/mol and a melting point in the range 60° C. to 170° C., preferably in the range 80° C. to 150° C.

The meaning of the expression “aliphatic polyesters” also includes polyesters made of aliphatic diols and of aliphatic dicarboxylic acids, for example polybutylene succinate (PBS), polybutylene adipate (PBA), polybutylene succinate adipate (PBSA), polybutylene succinate sebacate (PBSSe), polybutylene sebacate (PBSe) or corresponding polyesters having a partial polyesteramide structure or partial polyester urethane structure. The aliphatic polyesters are marketed by way of example as BIUOPBS by Mitsubishi. WO-A 2010/034711 describes more recent developments.

Mixtures of aliphatic and aliphatic-aromatic polyesters, or of the abovementioned aliphatic or aliphatic-aromatic polyesters, can moreover also be used, where the latter used preferably comprise polybutylene adipate-coterephthalate (PBAT), polybutylene sebacate-coterephthalate (PBSeT), and also mixtures of PBAT and PBSeT, and up to 44.99% by weight, preferably 1 to 29.9% by weight and with particular preference 1 to 10% by weight, of other biodegradable polymers selected from the group consisting of: polylactic acid (PLA), polycaprolactone (PCL), polypropylene carbonate, polyhydroxyalkanoate are added.

Compatibilizers, for example a) a copolymer which comprises epoxy groups and is based on styrene, acrylate and/or methacrylate, and/or b) a fatty acid amide, fatty acid ester, or natural oil comprising epoxy groups can be added to the polymer mixtures—in particular to those comprising polylactic acid.

The expression “copolymers which comprise epoxy groups and are based on styrene, acrylate and/or methacrylate” means the following structures a). The units bearing epoxy groups are preferably glycidyl (meth)acrylates. Copolymers that have proven advantageous have a glycidyl methacrylate content of the copolymer that is above 20% by weight, particularly preferably above 30% by weight and with particular preference above 50% by weight. The epoxy equivalent weight (EEW) in these polymers is preferably 150 to 3000 g/equivalent, and with particular preference 200 to 500 g/equivalent. The average molecular weight (weight average) M_{W} of the polymers is preferably 2000 to 25 000, in particular 3000 to 8000. The average molecular weight (number-average) Mₙ of the polymers is preferably 400 to 6000, in particular 1000 to 4000. The polydispersity (Q) is generally between 1.5 and 5. Copolymers of the abovementioned type which comprise epoxy groups are marketed by way of example by BASF Resins B.V. with trademark Joncryl® ADR. Joncryl® ADR 4368 or Joncryl ADR 4468C or Joncryl ADR 4468HP is particularly suitable as compatibilizer.

The quantity added of the compatibilizer a) is 0 to 2% by weight, preferably 0.05 to 0.6% by weight, based on the total weight of the starch mixture.

Fatty acid amides, fatty acid esters, or (epoxidized) natural oils comprising epoxy groups can moreover be used as compatibilizers b). The expression “natural oils” means by way of example olive oil, linseed oil, soybean oil, palm oil, peanut oil, coconut oil, seaweed oil, cod liver oil or a mixture of these compounds. Preference is in particular given to epoxidized soybean oil (e.g. Merginat® ESBO from Hobum, Hamburg, or Edenol® B 316 from Cognis, Dusseldorf. The compatibilizers of the structural types a) and b) can also be combined, an example being Joncryl® ADR 4368 (structural type a)) and Merginat® ESBO (structural type b).

The quantity added of the compatibilizer b) is usually 0 to 6% by weight, preferably 0.3 to 3% by weight, based on the total weight of the starch mixture.

In particular when compatibilizers b) are used, it is moreover possible to add organic acids to the reaction mixture, an example being malic acid, lactic acid, tartaric acid or citric acid. The acids are generally used at a concentration of 0.01 to 0.45% by weight and preferably 0.05 to 0.3% by weight, based on the total weight of the starch mixture.

Mineral fillers can also be added to the starch blends, an example being chalk, graphite, gypsum, conductive carbon black, iron oxide, calcium phosphate, dolomite, kaolin, silicon dioxide (quartz), sodium carbonate, titanium dioxide, silicate, wollastonite, mica, or montmorillonites. The quantity generally used of the mineral fillers is 0.1 to 20% by weight and preferably 2 to 15% by weight, based on the total weight of the starch mixture.

The starch blends of the invention can usually comprise further additives known to the person skilled in the art. Examples here are the additional substances conventionally used in plastics technology, for example stabilizers, nucleating agents such as the mineral fillers already mentioned above, and also crystalline polylactic acid; lubricants and release agents such as stearates (in particular calcium stearate): surfactants such as polysorbates, palmitates or laurates; antistatic agent, UV absorbers; UV stabilizers; antifogging agents, or colorants, for example graphite. The additives are generally used at concentrations of 0 to 2% by weight, in particular 0.1 to 2% by weight, based on the total weight of the starch mixture.

Another possibility, instead of use of mixtures of the abovementioned biodegradable polyesters or polycarbonates, is addition of these polyesters or polycarbonates into the extruder at different points. It is therefore possible that polyesters susceptible to hydrolysis, for example polybutylene succinate, polyhydroxyalkanoates, or polylactic acid are added at a point in the extruder at which, after prior devolatilization, the water content of the polymer melt has already been reduced.

The abovementioned polymers can moreover comprise further additives known to the person skilled in the art. Examples of these are the additional substances conventionally used in plastics technology, for example stabilizers, antiblocking agents, lubricants, nucleating agents, antistatic agent, UV absorber; plasticizers such as Citrofol, or antifogging agents such as Atmer, compatibilizers, for example a copolymer which comprises epoxy groups and is based on styrene, acrylate and/or methacrylate, or colorants. It is of course possible to use the additives conventionally used for starch blends, for example the organic acids and fatty acid esters described in EP0947559 and by Zhang et al., Polm. Adv. Technol. 2018 on pp. 1-11. Concentrations generally used in these additives are 0 to 2% by weight, in particular 0.1 to 1% by weight, based on the polyester mixture of the invention.

The abovementioned additives or auxiliaries can also be fed into the extruder separately from the starch-immiscible polymer.

The single-stage process of the invention has numerous advantages. The non-aggressive and efficient wetting of the starch by one or more plasticizers in the wetting section of the extruder leads, in the further course of the plastifying section, to non-aggressive gelatinization/thermoplastification of the starch and non-aggressive incorporation of the TPS into the matrix of the starch-immiscible polymer. In comparison with the processes described in the prior art, the processes under consideration take place in the presence of a considerable quantity of water in the plastifying section, generally between 1 and 20%, preferably 3 and 15%, particularly preferably 5 and 10%, based on the entirety of the anhydrous final products, and the starch is thus very substantially protected from any disadvantageous thermal degradation involving discoloration. At the same time, fine-particle dispersion of the starch in the polymer matrix is permitted, together with high throughputs and high starch contents in the polymer. It is moreover possible to avoid the addition of specific and expensive compatibilizers which are mostly added in the prior art in order to achieve dispersion of the TPS in the polymer.

With the process of the invention in claims 1 to 12, and preferably 10 to 12, it is therefore possible for the first time to produce, on a large industrial scale, starch blends with 39 to 47% by weight starch content, based on the entirety of anhydrous starch and of anhydrous plasticizer, together with a lightness value L* in accordance with EN ISO 11664-4 with L* above 75 and preferably above 80. It was moreover also possible to achieve values below 22 for b* (blue-yellow value) in accordance with EN ISO 11664-4. This was achieved even with corn starch, which has higher protein content than potato starch and therefore is significantly more susceptible to discoloration effect when exposed to thermal stress. The starch blends moreover had a surprisingly low content of cyclic impurities such as tetrahydrofuran (THF). The THF content of the starch mixtures produced by the process of claim 12 of the invention was generally below 10 ppm, in particular below 5 ppm and with particular preference below 3 ppm.

The process of the invention provides access to starch blends consisting primarily (to an extent above 50% by weight) and preferably above 60% of renewable feedstocks. The proportion of renewable feedstocks can be determined by the ¹⁴C method in accordance with the DIN CERTCO or Vincotte standard. These starch blends are also biodegradable in a garden compost heap in accordance with the OK Compost HOME standard of the Vincotte certification system. Because the starch blends can be produced with almost no undispersed particles, they can be drawn to give thin films with thickness below 20 micrometers, and preferably below 10 micrometers. Because of the uniform dispersion of the starch particles in the polymer matrix, the films have very good mechanical properties, for example in particular high tensile strength, and also high tear-propagation resistance.

Preferred starch blends having the abovementioned property profile have the following composition:
i) 53 to 61% by weight of a polybutylene adipate-coterephthalate (PBAT) and/or polybutylene sebacate-coterephthalate (PBSeT), respectively comprising 1,4-butanediol from renewable sources;
ii) 39 to 47% by weight of a thermoplastic starch.

In particular, preference is given to starch blends which have the abovementioned property profile and have the following composition:
i) 45.4 to 62.95% by weight of a PBAT and/or PBSeT, comprising 1,4-butanediol from renewable sources;
ii) 35 to 47% by weight of a thermoplastic starch,
iii) 2 to 7% by weight of polylactic acid;
iv) 0.05 to 0.6% by weight of a copolymer which comprises epoxy groups and is based on styrene, acrylate and/or methacrylate.

### WORKING EXAMPLES

### Starting Materials:

A1) Ecoflex® F Blend C1200, aliphatic-aromatic polyester from BASF with MVR of 3 to 5 cm³/10 min at 190° C./2.16 kg.
B1) Native corn starch, water content about 12%.
C1) Neosorb 70/70—sorbitol solution with very low susceptibility to crystallization from Roquette, solids content 70%, sorbitol content at least 50%.

### Description of Extruders Used:

E1) ZSK 40 MC corotating twin-screw extruder from Coperion, diameter 40 mm, 14 electrically heatable and water-coolable barrel zones with length respectively 4D, L/D=56 with a wetting section of length 20D, into which three kneading blocks were incorporated. Motor power rating 130 kW, specific torque 11.5 Nm/cm³.

### Description of Blown Film Plants:

Blown film plant consisting of a single-screw extruder with diameter 30 mm and length 25D, spiral mandrel distributor with 80 mm diameter and die gap 0.8 mm. Blow-up ratio is typically 3.5, resulting in a laid-flat film-bubble width of about 440 mm.

### Analysis:

Determination of water content: The residual water content of the granulates was determined by the Karl Fischer method (Mettler-Toledo InMotion KF).

Melt volume rate: Melt volume rate was determined in accordance with EN ISO 1133 at the stated temperatures and with the stated weights, and is stated in cm3/10 min.

Average starch particle diameter: A sample was obtained at −80° C. from the film produced in example 2 by microtome section parallel to the extrusion direction. This sample was studied by atomic force microscopy on portions measuring respectively 15×15 micrometers. The relatively hard TPS phase can be distinguished very easily from the relatively soft polymer phase, and permits precise determination of blend morphology and particle sizes of the starch particles dispersed in the polymer. Evaluation of particle sizes gave an average particle size of 466 nanometers and a maximal particle diameter of only 1488 nanometers; this is evidence of the very fine-particle dispersion of the starch particles in the polymer phase.

THF determination: The THF determination was carried out by Headspace GC-MS based on DIN 38407-F 43 2014-10 and LA-GC-013.071 (Headspace GC-MS determination of volatile organic substances in low-fat foods). For this, a suitable quantity of the specimen is dissolved in dimethylacetamide and THF-d8 is added as internal standard. The specimen sealed in the glass Headspace GC bottle is heated at 85° C. for 30 min in the Headspace oven in an Agilent HS GC/MS, and then subjected to measurement. Helium is used as carrier gas. The value is externally calibrated on the basis of recovery of the internal standard (THF-d8) and matrix effect control (Matrix Spike).

Determination of lightness value L* and of b* value: Both values were determined in accordance with EN ISO 11664-4 (CIE 15:2004). The average value was calculated from 4 measurements on granulate grains (size between 3 and 8 mm, in layers of thickness 2 cm in order to ensure that they formed an opaque layer. Between the four measurements, the container was rotated by respectively 90°. A Datacolor 650 was used for the measurement. The measurement was made with spherical geometry, d/8°, with specular component included (SCI), and standard illuminant D65 in combination with the CIE 1963 10° standard observer.

### Inventive Examples

### Examples 1 to 7 (Extruder E1, Embodiment B)

Gravimetric metering systems were used for addition of all starting materials. The native starches B were added in powder form into zone 1 of the extruder. A gravimetrically controlled gear pump was used to add the plasticizer(s) C, for example in the middle of zone 2. The starting material A was added by way of a side feeder (ZSB) in granulate form in zone 6 of the extruder. Between the plasticizer-addition point in zone 2 and the polymer-addition point in zone 6 there were not only conveying elements installed but also 1-5 mixing elements (neutral kneading blocks and/or toothed reverse-conveying mixing elements). Excess water was removed in zone 13 via a 40 mm lateral devolatilization unit, and the product was extruded by way of a die plate in the form of strands, which were cooled in a water bath and granulated.

The polymer granules were then dried at 70° C. to the residual moisture levels stated in the table.

### Example 8 (Extruder E1, Embodiment A)

Gravimetric metering systems were used for addition of all starting materials. The native starches B and the starting material A were added in zone 1 of the extruder by way of 2 separate gravimetric metering systems. The plasticizer(s) C was/were added in liquid form approximately in the middle of zone 2 by using a gravimetrically controlled gear pump. Zones 1-6 used exclusively conveying screw elements. Excess water was removed in zone 13 via a 40 mm lateral devolatilization system, and the product was extruded by way of a die plate in the form of strands, which were cooled and granulated in a water bath.

The polymer granulates were then dried at 70° C. to the residual moisture levels stated in the table.

| | Example 1 | Example 2 | Example 3 | Example 4 | Example 5 |
|---|---|---|---|---|---|
| Extruder | E1 | E1 | E1 | E1 | E1 |
| Rotation rate | 350 | 350 | 350 | 350 | 350 |
| rpm | | | | | |
| Temperature | Set/actual | Set/actual | Set/actual | Set/actual | Set/actual |
| profile/° C. | | | | | |
| Zone 1 | WC*/31 | Water | WC*/34 | WC*/31 | WC*/32 |
| | | cooling | | | |
| | | WC*/33 | | | |
| Zone 2 | 30/38 | 30/39 | 30/38 | 30/36 | 30/37 |
| Zone 3 | 30/42 | 30/46 | 30/46 | 30/43 | 30/44 |
| Zone 4 | 30/46 | 30/48 | 30/49 | 30/43 | 30/44 |
| Zone 5 | 30/56 | 30/57 | 30/58 | 30/49 | 30/49 |
| Zone 6 | 30/57 | 30/97 | 30/98 | 30/50 | 30/51 |
| Zone 7 | 60/57 | 120/119 | 120/121 | 60/62 | 60/60 |
| Zone 8 | 140/137 | 140/141 | 140/144 | 140/138 | 140/143 |
| Zone 9 | 160/158 | 160/160 | 160/160 | 160/160 | 160/160 |
| Zone 10 | 160/160 | 160/160 | 160/160 | 160/160 | 160/160 |
| Zone 11 | 160/178 | 160/179 | 160/178 | 160/186 | 160/180 |
| Zone 12 | 160/160 | 160/160 | 160/160 | 160/164 | 160/163 |
| Zone 13 | 160/159 | 160/160 | 160/160 | 160/160 | 160/162 |
| Zone 14 | 160/173 | 160/175 | 160/171 | 160/177 | 160/168 |
| Zone 15 | 160/164 | 160/164 | 160/161 | 160/167 | 160/161 |
| (head) | | | | | |
| Wetting section ** | 20D | 20D | 20D | 20D | 20D |

*WC = water cooling, not controllable
** defined as distance from addition of plasticizer (all or part) to beginning of starch melting zone/plastifying zone in multiples of the extruder diameter D.

| | Example 1 | Example 2 | Example 3 | Example 4 | Example 5 |
|---|---|---|---|---|---|
| Quantity of A1 | 65.0/Z6 | 65.0 (Z6) | 60.0 (Z6) | 65/Z6 | 60.0/Z6 |
| added & zone (kg/h) | | | | | |
| Quantity of B1 | 29.5 | 29.5 | 33.7 | 29.5 | 33.7 |
| added (kg/h) | | | | | |
| Quantity of C1 | 13.0 | 13.0 | 14.0 | 11.5 | 14.0 |
| added (kg/h) | | | | | |
| Total report/kg/h | 107.5 | 107.5 | 107.7 | 105.5 | 107.7 |
| Melt temperature | 209 | 213 | 205 | 210 | 201 |
| (at die exit in ° C.) | | | | | |
| TPS content in final | 35.0 | 35.0 | 39.7 | 34.4 | 39.7 |
| product/% | | | | | |
| Residual moisture | 850 | 720 | 860 | 1910 | 2490 |
| level after drying | | | | | |
| (ppm) | | | | | |
| MVR after drying | 4.5 | 4.5 | 3.6 | 4.8 | 4.1 |
| (190° C., 5 kg) | | | | | |
| Film extruder | | | | | |
| Rotation rate (rpm) | 80 | 80 | 80 | 80 | 80 |
| Temperature profile (° C.) | | | | | |
| Intake zone | water- | water- | water- | water- | water- |
| | cooled | cooled | cooled | cooled | cooled |
| Zone 1 | 120 | 120 | 120 | 120 | 120 |
| Zone 2 | 170 | 170 | 170 | 170 | 170 |
| Zone 3 | 170 | 170 | 170 | 170 | 170 |
| Flange | 170 | 170 | 170 | 170 | 170 |
| Elbow | 170 | 170 | 170 | 170 | 170 |
| Spiral mandrel | 170 | 170 | 170 | 170 | 170 |
| distributor | | | | | |
| Die | 170 | 170 | 170 | 170 | 170 |
| Blow-up ratio | 1:3.5 | 1:3.5 | 1:3.5 | 1:3.5 | 1:3.5 |
| Film thickness | 14.9 | 14.9 | 15.4 | 14.9 | 14.6 and |
| (μm, from weight | | | | | 9.0* |
| per unit area) | | | | | |
| Film thickness | 16 | 17 | 19 | 17 | 18/11 |
| (μm, via film | | | | | |
| gauge) | | | | | |
| Visual assessment | 1 | 1 | 1 | 1 | 1 |
| of film ** | | | | | |
| L* (lightness | — | — | — | — | 83.04*** |
| value) | | | | | |
| b* (blue-yellow | — | — | — | — | 18.2*** |
| value) | | | | | |
| THF content for | — | — | — | — | 2.3 ppm |
| drying | | | | | |

*The maximal possible take-off velocity of the film plant B2 of 30/min limits the minimal achievable film thickness to 9 micrometers - the quality of the starch blend would also allow production of even thinner films.
** 1: few, and only small, undispersed particles, no holes 2: few undispersed particles, some of which are somewhat larger, no holes 3: more undispersed particles, also occasional medium- to large-sized undispersed particles, occasional holes 4: many medium- and some larger-sized undispersed particles, regular occurrence of holes, film only just runnable 5: many medium- and also some large-sized undispersed particles, frequent holes, stable running of film not achievable over a prolonged period 6: many medium-sized and large undispersed particles, holes constantly occurring, film continually collapses
***a blend made of 60 kg/h of A1, 33.7 kg/h of B1 and 14.0 kg/h of C1 was produced in the extruder E1 by a method based on the extruder configuration from example 1 in EP 2467418A1. At a rotation rate of 350 rpm, the melt temperature at the die exit was 248° C. The resultant blown films had a considerably higher number of starch agglomerates than in example 5, and could not be drawn to thicknesses below about 25 micrometers, because of constant occurrence of holes. The product moreover exhibited brownish discoloration. The lightness value L* of the granulate was as low as 72.96, and the b* value was 24.29, i.e. the granulate was significantly darker than the granulate of the invention from example 5, and had a higher yellow value.

| | Example 1 | Example 2 | Example 3 | Example 4 | Example 5 |
|---|---|---|---|---|---|
| TPS content in | 35 | 35 | 40 | 34 | 40 |
| blend/% | | | | | |
| Film thickness (μm, | 14.9 | 14.9 | 15.4 | 14.9 | 14.6/9.0 |
| from weight per | | | | | |
| unit area) | | | | | |
| Film thickness (μm, | 16 | 17 | 19 | 17 | 18/11 |
| via film cage) | | | | | |
| Tensile test in machine | | | | | |
| direction | | | | | |
| Modulus of elasticity/ | 144 | 131 | 162 | 175 | 146/142 |
| MPa | | | | | |
| Tensile stress at | — | — | — | — | —/— |
| yield/MPa | | | | | |
| Tensile strain at | — | — | — | — | —/— |
| yield/% | | | | | |
| Tensile strength/ | 27.8 | 25.5 | 23.3 | 30.9 | 21.5/23.4 |
| MPa | | | | | |
| Tensile strain at | 338 | 419 | 318 | 409 | 317/168 |
| max. tensile | | | | | |
| strength/% | | | | | |
| Tear strength/MPa | 22.9 | 23.8 | 18.8 | 29.7 | 18.7/14.7 |
| Tensile strain at | 347 | 424 | 326 | 414 | 328/181 |
| break/% | | | | | |
| Tensile test in | | | | | |
| transverse direction | | | | | |
| Modulus of elasticity/ | 132 | 160 | 161 | 157 | 163/120 |
| MPa | | | | | |
| Tensile stress at | — | 9.2 | — | 8.8 | —/— |
| yield/MPa | | | | | |
| Tensile strain at | — | 17.0 | — | 22.1 | —/— |
| yield/% | | | | | |
| Tensile strength/ | 21.2 | 22.0 | 17.7 | 22.8 | 16.6/15.7 |
| MPa | | | | | |
| Tensile strain at | 498 | 535 | 434 | 492 | 421/392 |
| max. tensile | | | | | |
| strength/% | | | | | |
| Tear strength/MPa | 20.2 | 20.5 | 17.2 | 22.0 | 16.3/14.4 |
| Tensile strain at | 502 | 539 | 438 | 494 | 425/399 |
| break/[% | | | | | |
| Dart drop W_{F}/g | 198 | 210 | 156 | 141 | 135 |
| Tear propagation | 1415 | 1359 | 1906 | 2054 | 1605/525 |
| resistance in | | | | | |
| machine | | | | | |
| direction/mN | | | | | |
| Tear propagation | 4105 | 3687 | 5024 | 4506 | 4318/2278 |
| resistance in | | | | | |
| transverse | | | | | |
| direction/mN | | | | | |

| | Example 6 | Example 7 | Example 8 |
|---|---|---|---|
| Extruder | E1 | E1 | E1 |
| Rotation rate, rpm | 300 | 350 | 400 |
| Temperature profile/° C. | Set/actual | Set/actual | Set/actual |
| Zone 1 | water cooling | water cooling | WC/29 |
| | WC*/29 | WC*/31 | |
| Zone 2 | 30/32 | 30/33 | 30/29 |
| Zone 3 | 30/29 | 30/31 | 30/29 |
| Zone 4 | 30/28 | 30/31 | 30/29 |
| Zone 5 | 30/33 | 30/37 | 30/31 |
| Zone 6 | 30/38 | 30/41 | 50/51 |
| Zone 7 | 30/42 | 30/46 | 140/142 |
| Zone 8 | 140/117 | 140/132 | 160/163 |
| Zone 9 | 160/160 | 160/160 | 160/160 |
| Zone 10 | 160/160 | 160/161 | 160/160 |
| Zone 11 | 160/160 | 160/169 | 160/185 |
| Zone 12 | 160/170 | 160/165 | 160/150 |
| Zone 13 | 160/162 | 160/158 | 160/166 |
| Zone 14 | 160/150 | 160/157 | 160/193 |
| Zone 15 | 160 (head)/161 | 160 (head)/161 | 160/178 |
| Wetting section ** | 22D | 22D | 18D |

*WC = water cooling, not controllable
** defined as distance from addition of plasticizer (all or part) to beginning of starch melting zone/plastifying zone in multiples of the extruder diameter D.

| | Example 6 | Example 7 | Example 8 |
|---|---|---|---|
| Quantity of A1 | 65/Z6 | 78/Z6 | 105/Z1 |
| added & zone (kg/h) | | | |
| Quantity of B1 added | 29.5 | 35.4 | 37.8 |
| (kg/h) | | | |
| Quantity of C1 | 13 | 15.6 | 16.8 |
| added (kg/h) | | | |
| Total throughput/ | 107.5 | 129 | 159.6 |
| kg/h | | | |
| Melt temperature (at | 198 | 200 | 220 |
| die exit in ° C.) | | | |
| TPS content in final | 35.0 | 35.0 | 30.0 |
| product/% | | | |
| Residual moisture | 2400 | 2170 | 760 |
| level after drying | | | |
| (ppm) | | | |
| MVR after drying | 3.2 | 5.4 | 4.0 |
| (190° C., 5 kg) | | | |
| Film extrusion | | | |
| Rotation rate (rpm) | 80 | 80 | 80 |
| Temperature profile | | | |
| (° C.) | | | |
| Intake zone | water cooling | water cooling | water cooling |
| Zone 1 | 120 | 120 | 120 |
| Zone 2 | 170 | 170 | 170 |
| Zone 3 | 170 | 170 | 170 |
| Flange | 170 | 170 | 170 |
| Elbow | 170 | 170 | 170 |
| Spiral mandrel distributor | 170 | 170 | 170 |
| Die | 170 | 170 | 170 |
| Blow-up ratio | 1:3.5 | 1:3.5 | 1:3.5 |
| Film thickness (μm, | 15.3 | 15.8 | 15.3 |
| from weight per unit | | | |
| area) | | | |
| Film thickness (μm, | 21.5 | 18.0 | 17.8 |
| via film gauge) | | | |
| Visual assessment of | 2 | 1 | 1 |
| film* | | | |

** 1: few, and only small, undispersed particles, no holes 2: few undispersed particles, some of which are somewhat larger, no holes 3: more undispersed particles, also occasional medium- to large-sized undispersed particles, occasional holes 4: many medium- and some larger-sized undispersed particles, regular occurrence of holes, film only just runnable 5: many medium- and also some large-sized undispersed particles, frequent holes, stable running of film not achievable over a prolonged period 6: many medium-sized and large undispersed particles, holes constantly occurring, film continually collapses

| | Example 6 | Example 7 | Example 8 |
|---|---|---|---|
| TPS content in blend/% | 35.0 | 35.0 | 30.0 |
| Film thickness (μm, | 15.3 | 15.8 | 15.3 |
| from weight per unit | | | |
| area) | | | |
| Film thickness (μm, | 21.5 | 18.0 | 17.8 |
| via film gauge) | | | |
| Tensile test in | | | not determined |
| machine direction | | | |
| Modulus of elasticity/MPa | 153 | 142 | |
| Tensile stress at yield/MPa | — | — | |
| Tensile strain at yield/% | — | — | |
| Tensile strength/MPa | 22.6 | 29.2 | |
| Tensile strain at max. | 266 | 381 | |
| tensile strength/% | | | |
| Tear strength/MPa | 21.9 | 26.5 | |
| Tensile strain at | 269 | 385 | |
| break/% | | | |
| Tensile test in | | | not determined |
| transverse direction | | | |
| Modulus of elasticity/MPa | 165 | 127 | |
| Tensile stress at yield/MPa | — | — | |
| Tensile strain at yield/% | — | — | |
| Tensile strength/MPa | 16.5 | 19.6 | |
| Tensile strain at max. | 365 | 465 | |
| tensile strength/% | | | |
| Tear strength/MPa | 15.9 | 19.3 | |
| Tensile strain at | 368 | 468 | |
| break/% | | | |
| Dart drop W_{F}/g | 123 | 381 | not determined |
| Tear propagation | 1235 | 1304 | not determined |
| resistance in machine | | | |
| direction/mN | | | |
| Tear propagation | 3009 | 4051 | not determined |
| resistance in | | | |
| transverse direction/mN | | | |

### Example 9

With parameters the same as those in example 5, a blend was compounded from 54.8% of partially biobased Bio-PBAT (the same as A1, but with 100% biobased bio-BDO produced by fermentation instead of fossil BDO), 5% of polylactic acid 4043D from Natureworks, 0.2% of Joncryl ADR 4468, 33.7% of 61 and 14.0% of C1. The polylactic acid and the Joncryl were added together with the bio-PBAT. MVR after drying was 2.8 (190° C./5 kg), the lightness value L* was 83.64 and the b* value was 17.8. The compounded material could be processed without difficulty with parameters the same as those of example 5 to give a thin film of thickness 10 micrometers which was practically free from undispersed particles while having good mechanical properties sufficient for a fruit and vegetable bag (in particular in respect of tear-propagation behavior perpendicular to machine direction), with biobased ¹⁷C content of about 60%, higher than in example 5.

1. A single-stage process for the production of starch blends in a twin-screw extruder, where
i) the starch, together with a plasticizer, passes through a wetting section of length 8D to 30D in an extruder at temperatures below 85° C., with mixing, where D is defined as the screw diameter of the screw cylinder and the wetting section is defined as starting at that point on the extruder screw at which the starch and the entire or partial quantity of plasticizer encounter one another and ending at that point in the extruder at which the starch is gelatinized and is digested to give thermoplastic starch;
ii) in a plastifying section of length 10D to 50D the extruder temperature is adjusted stepwise to above 130° C., where the starch is digested, destructured and thermoplastified, and is dispersed in the starch-immiscible polymer, and a water content below 5%, based on the starch blend, is established before the material leaves the extruder;
where the starch-immiscible polymer is added in molten or granular form at any desired point in the extruder, and a mixture of all of the components present is consequently produced.

2. A process for the production of starch blends in two twin-screw extruders arranged in series, where
i) the starch, together with a plasticizer, passes through a wetting section of length 8D to 80D at temperatures below 85° C., with mixing, where D is defined as the screw diameter of the screw cylinder and the wetting section is defined as starting at that point on the extruder screw at which the starch and the entire or partial quantity of plasticizer encounter one another and ending at that point in the extruder at which the starch is gelatinized and is digested to give thermoplastic starch;
ii) in a plastifying section of length 10D to 50D the extruder temperature is adjusted stepwise to above 130° C., where the starch is digested, destructured and thermoplastified, and is dispersed in the starch-immiscible polymer, and a water content below 5%, based on the starch blend, is established before the material leaves the extruder;
where the starch-immiscible polymer is added in molten or granular form at any desired point in the extruder, and a mixture of all of the components present is consequently produced.

3. The process according to claim 1, where the length of the wetting section is at least 12D.

4. The process according to claim 1, where the temperature of the wetting section is kept below 60° C.

5. The process according to claim 1, where the starch-immiscible polymer is added in solid form before the beginning of the wetting section.

6. The process according to claim 1, where the wetting section also comprises, alongside purely conveying elements, additional intensified mixing screw elements, and the starch-immiscible polymer is added only downstream of the additional mixing screw elements of the wetting section.

7. The process according to claim 6, where the polymer is added in solid form.

8. The process according to claim 6, where the polymer is added before the dispersion phase.

9. The process according to claim 1, where the minimal length of the extruder is 44D.

10. The process according to claim 1, where the plasticizer is selected from water, glycerol, sorbitol and oligomerized glycerol and mixtures of these compounds.

11. The process according to claim 10, where the plasticizer comprises an aqueous sorbitol solution with 5 to 80% water content.

12. The process according to claim 11, where the aqueous sorbitol solution has been produced by hydrogenation of an incompletely depolymerized starch solution which still comprises significant proportions of at least 5% of compounds having higher molecular weight than sorbitol, based on the anhydrous mixture.

13. The process according to claim 1, where the polymer comprises an aliphatic or aliphatic-aromatic polyester which comprises, as diol component, 1,4-butanediol and is biodegradable in accordance with EN13432.

14. A starch blend with 39 to 47% by weight of content of thermoplastified starch, based on the entirety of anhydrous starch and of anhydrous plasticizer, and with a lightness value L* in accordance with EN ISO 11664-4/CIE 15:2004 that is greater than 75, obtainable by a process according to claim 1.

15. The starch blend according to claim 14 and with a lightness value L* in accordance with EN ISO 11664-4/CIE 15:2004 that is greater than 80, and with THF content below 5 ppm.

16. A starch blend consisting to an extent above 50%, of renewable feedstocks, comprising:
i) 53 to 61% by weight of a polybutylene adipate-co-terephthalate (PBAT) and/or polybutylene sebacate-co-terephthalate (PBSeT), based on 1,4-butanediol from renewable sources; and
ii) 39 to 47% by weight of a thermoplastified starch.

17. A starch blend, comprising:
i) 45.4 to 62.95% by weight of a polybutylene adipate-co-terephthalate (PBAT) and/or polybutylene sebacate-co-terephthalate (PBSeT), based on 1,4-butanediol from renewable sources; and
ii) 35 to 47% by weight of a thermoplastified starch;
iii) 2 to 7% by weight of polylactic acid; and
iv) 0.05 to 0.6% by weight of a copolymer which comprises epoxy groups and is based on styrene, acrylate and/or methacrylate.

18. The starch blend according to claim 15, where starch used comprises corn starch, wheat starch or pea starch.

19. The starch blend according to claim 18, where starch used comprises corn starch.
